(19) United States
(12) Patent Application Publication
(10) Pub. No.: US 2015/0171607 A1
(43) Pub. Date: Jun. 18, 2015

(54) JUNCTION BOX EXTENSIONS

(71) Applicant: Ronald J. Miller, Beavercreek, OH (US)

(72) Inventor: Ronald J. Miller, Beavercreek, OH (US)

(21) Appl. No.: 14/563,379

(22) Filed: Dec. 8, 2014

Related U.S. Application Data
(60) Provisional application No. 61/915,223, filed on Dec. 12, 2013.

(51) Int. Cl. H02G 3/08

(52) U.S. Cl. CPC H02G 3/086

(57) ABSTRACT

The present disclosure relates to electrical junction box extensions. During the installation of conduit and wiring systems, electrical junction boxes can become overfilled with too many conductors, and may not meet code. Either the junction box must be replaced with a larger box, or a box extension must be attached. However, replacing a junction box wastes time, and junction box extensions are costly, and requires excessive additional inventory. The proposed solution is to attach a second identical, or substantially identical, junction box to the first junction box. Only minor manufacturing modifications to the standard junction boxes are required to employ the disclosed extension methods, and the disclosed methods work for a wide variety of box sizes. Several embodiments are disclosed, each consisting of inexpensive ways to quickly attach and secure two junction boxes together, thereby doubling the available volume.

### CROSS-REFERENCE TO RELATED APPLICATIONS

This application claims the benefit of U.S. Provisional Application Ser. No. 61/915,223, filed Dec. 12, 2013.

### SUMMARY

The present disclosure relates to electrical junction box extensions. During the installation of conduit and wiring systems, electrical junction boxes can become overfilled with too many conductors, and may not meet code. Either the junction box must be replaced with a larger box, or a box extension must be attached. However, replacing a junction box wastes time, and junction box extensions are costly, and requires excessive additional inventory. The proposed solution is to attach a second identical, or substantially identical, junction box to the first junction box. Only minor manufacturing modifications to the standard junction boxes are required to employ the disclosed extension methods, and the disclosed methods work for a wide variety of box sizes. Several embodiments are disclosed, each consisting of inexpensive ways to quickly attach and secure two junction boxes together, thereby doubling the available volume.

### BRIEF DESCRIPTION OF THE DRAWINGS

FIGS. 1A-1H show an embodiment in which two junction boxes have pre-formed holes or pre-punched knockouts that enable expansion screws to secure the boxes together with pre-formed tabs.

FIGS. 2A-2D show an embodiment in which expansion screws are inserted into isolating sleeves to secure two junction boxes together.

FIGS. 3A-3E show an embodiment in which two junction boxes are secured together with a corner clip that is affixed to one of the junction boxes with an expansion screw.

FIGS. 4A-4D show an embodiment in which two junction boxes are secured together with back-to-back clips.

FIGS. 5A-5D show an embodiment in which two junction boxes are secured together with hook fasteners.

FIGS. 6A-6D show an embodiment in which two junction boxes are secured together with hinge fasteners.

### DETAILED DESCRIPTION

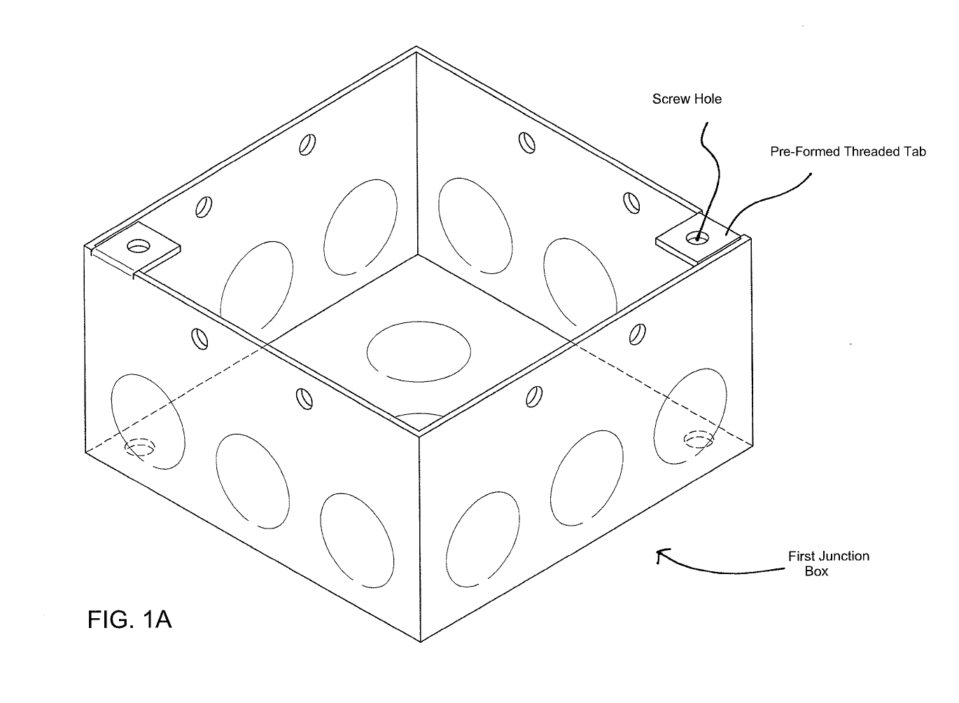

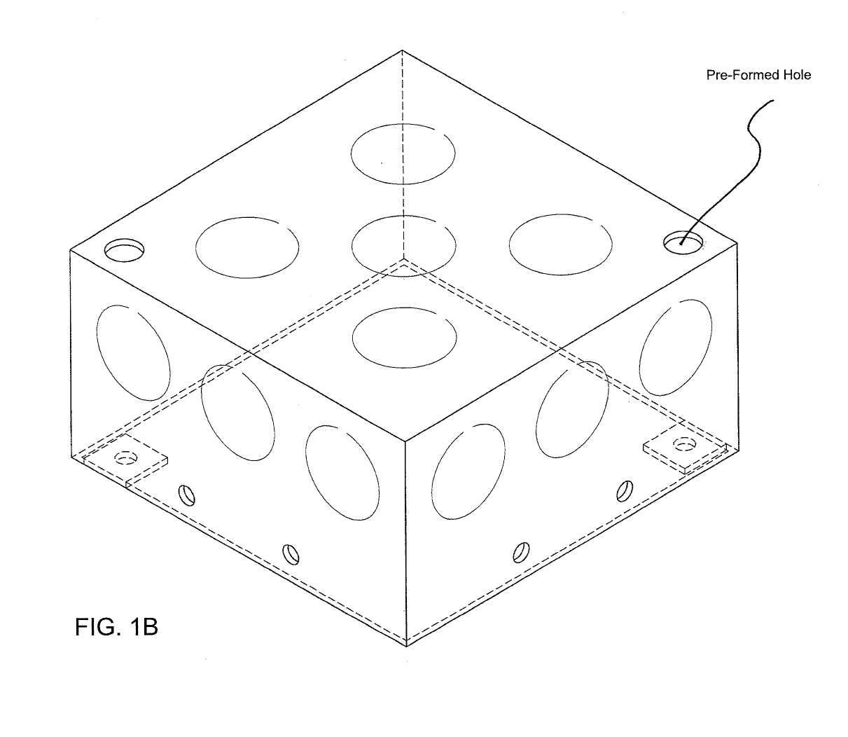

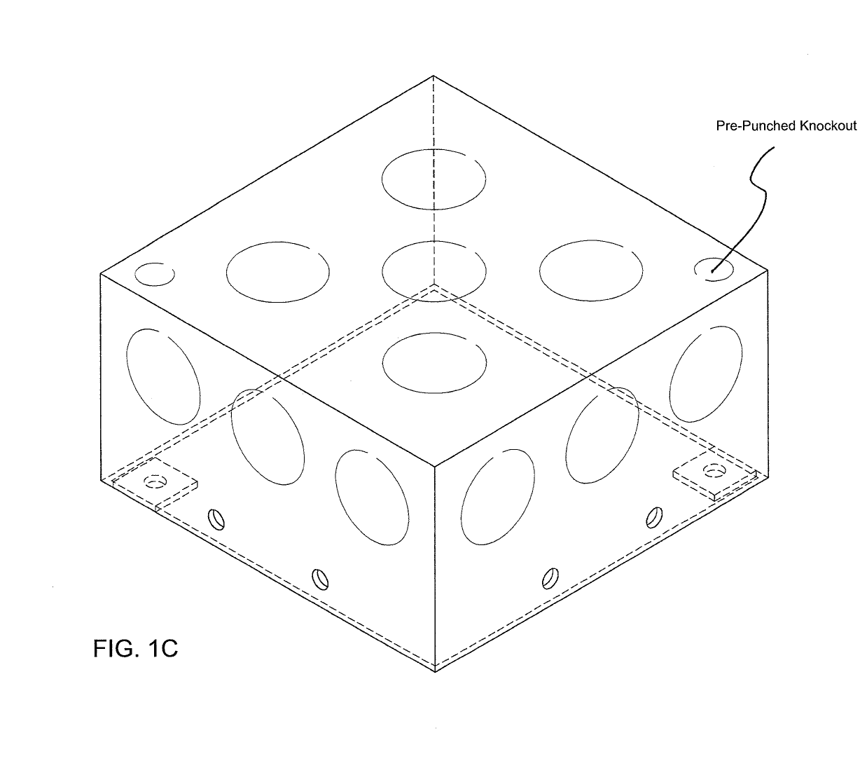

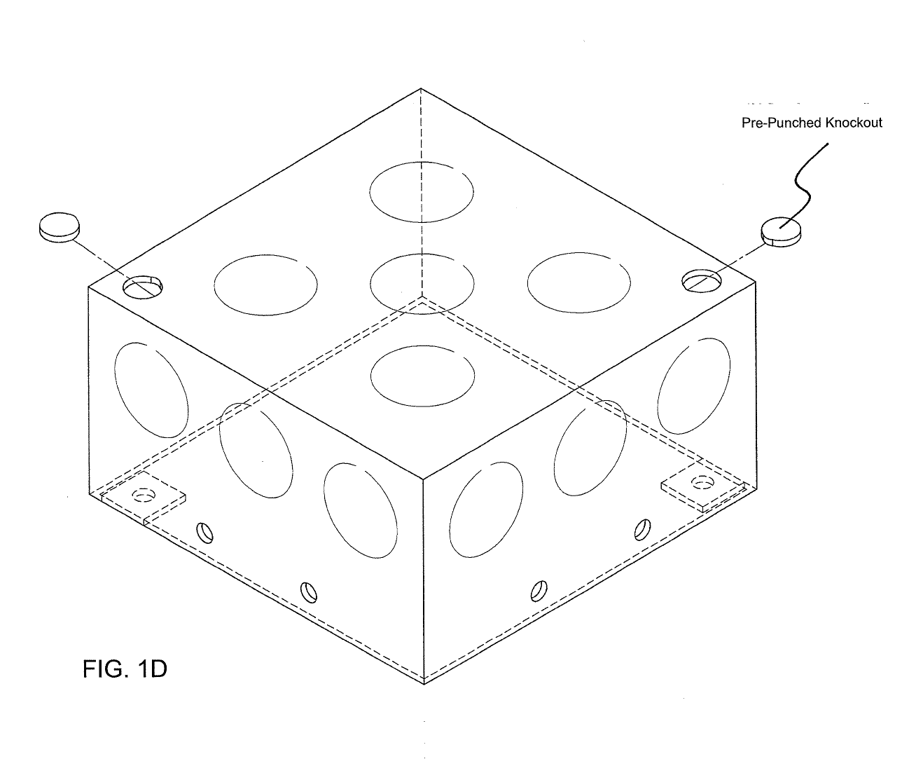

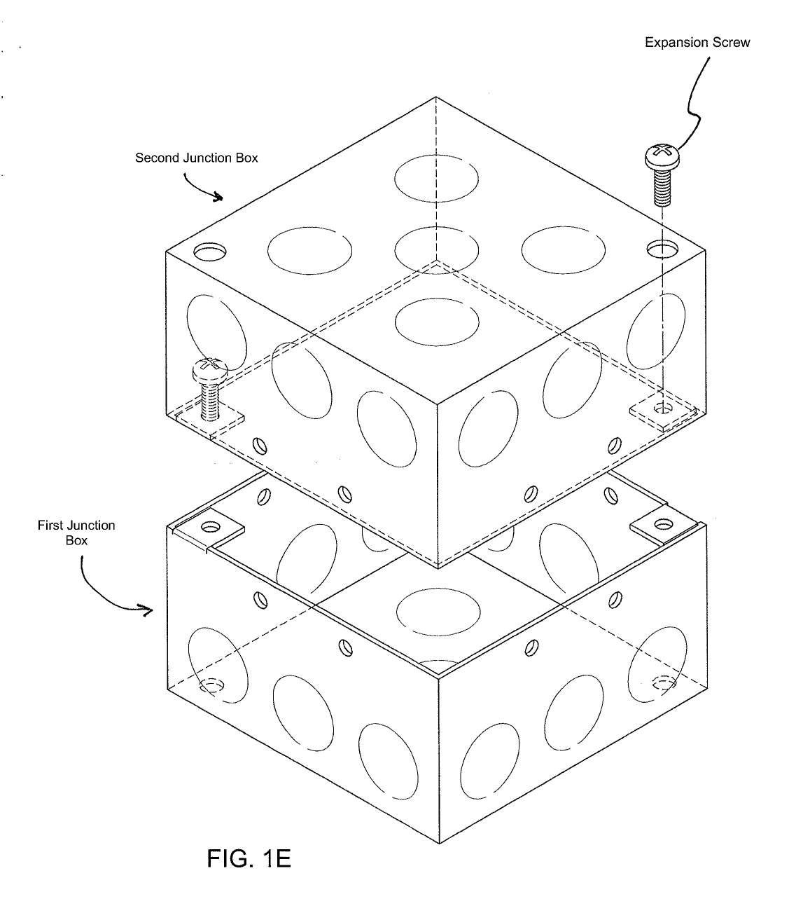

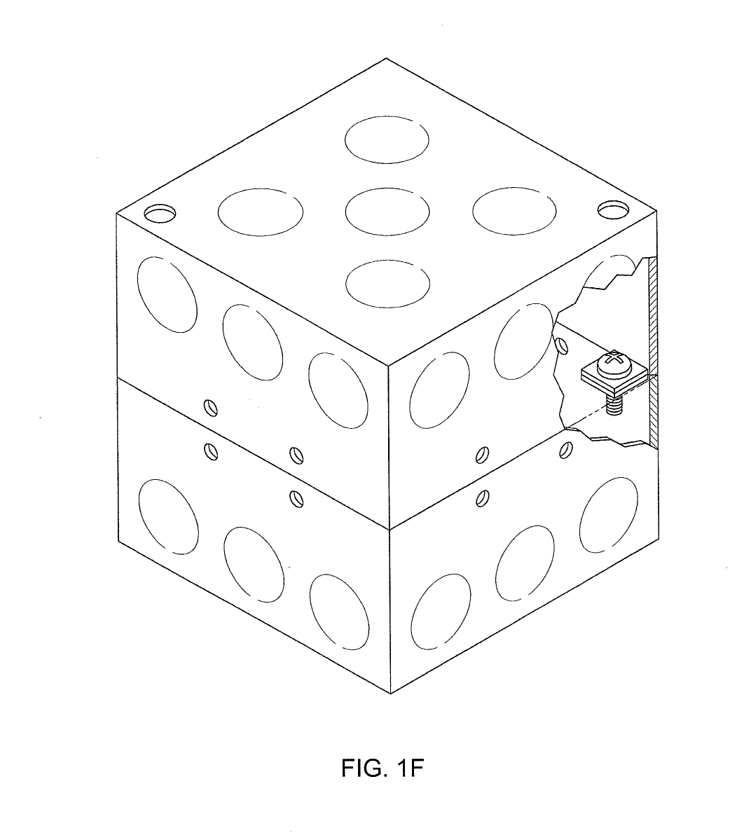

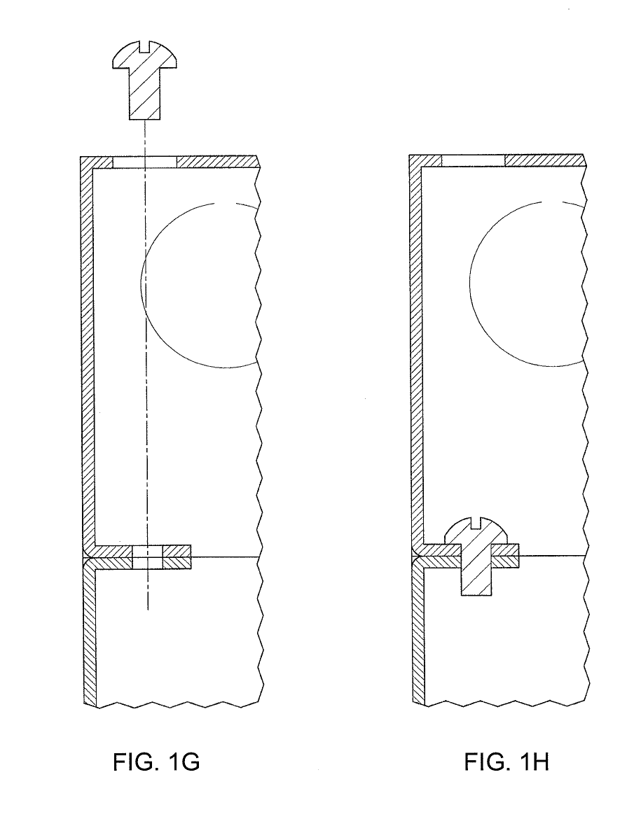

FIGS. 1A-1H show an embodiment in which two junction boxes have pre-formed holes or pre-punched knockouts that enable expansion screws to secure the boxes together with pre-formed tabs.

FIG. 1A shows a first junction box. The first junction box shown is a common size, i.e., 4″ high by 4″ wide by 2⅛″ deep. However, the method for efficiently extending the volume of junction boxes described in this application is independent of box size, and works for a wide variety of junction box sizes. Two pre-formed tabs are shown at the corners of the junction box, with a screw hole in the pre-formed tab.

FIG. 1B shows the first junction box in an inverted orientation. Two pre-formed holes are shown at the corners, directly above the pre-formed tabs and screw holes.

FIG. 1C shows the inverted junction box of FIG. 1B, but with two pre-punched knockout holes at the corners, instead of the pre-formed holes, directly above the pre-formed tabs and screw holes.

FIG. 1D shows the inverted junction box with the pre-punched knockouts removed.

In FIG. 1E, the second junction box is shown directly above the first junction box. The second junction box is the same junction box as the first junction box, but in an inverted orientation, as shown in FIG. 1B. An expansion screw is threaded through the corresponding screw holes of the pre-formed tabs in the first and second junction box. The expansion screws are commonly 8-32 machine screws of varying lengths.

FIG. 1F shows the two junction boxes screwed together in the completed state. By securing the first and second junction boxes together the volume of the junction box is effectively doubled.

FIG. 1G shows the expansion screw in preparation for securing the two junction boxes together.

FIG. 1H shows the two junction boxes secured together and held in place by the expansion screw.

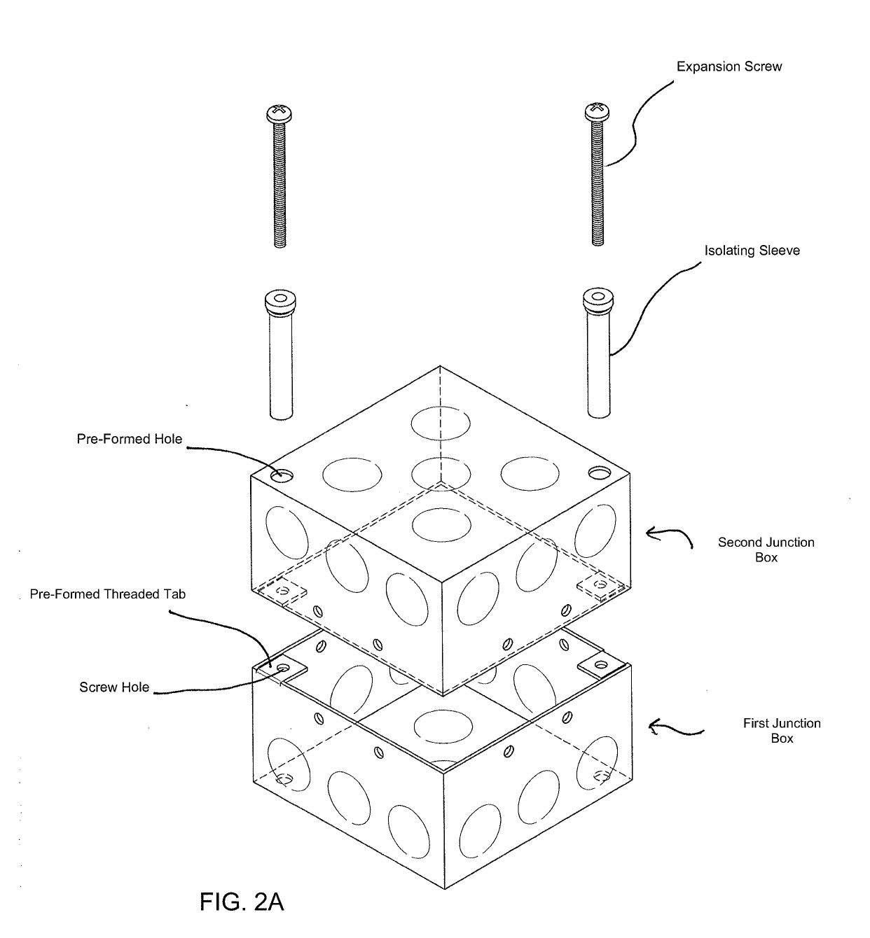

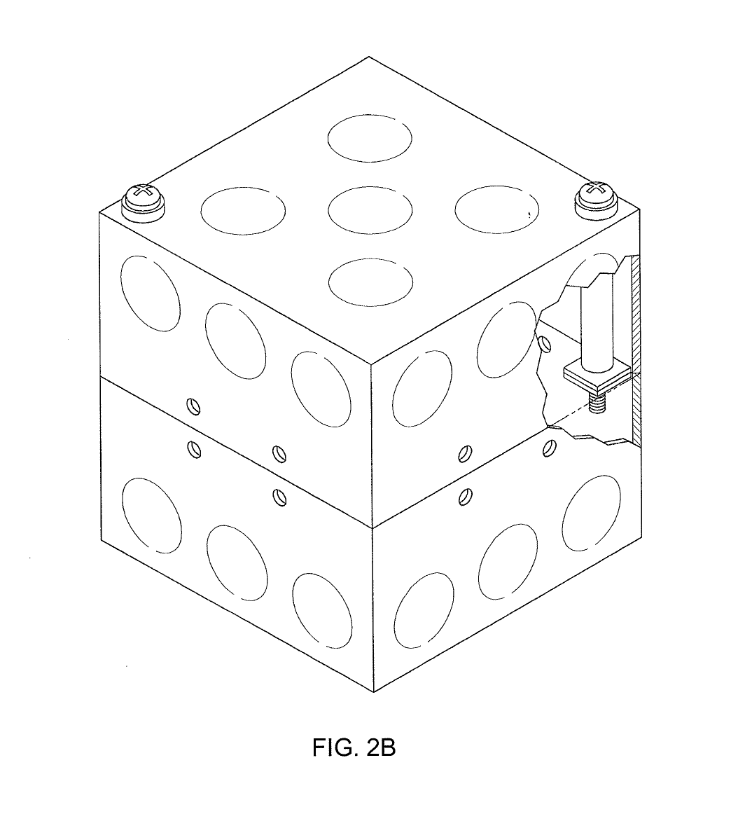

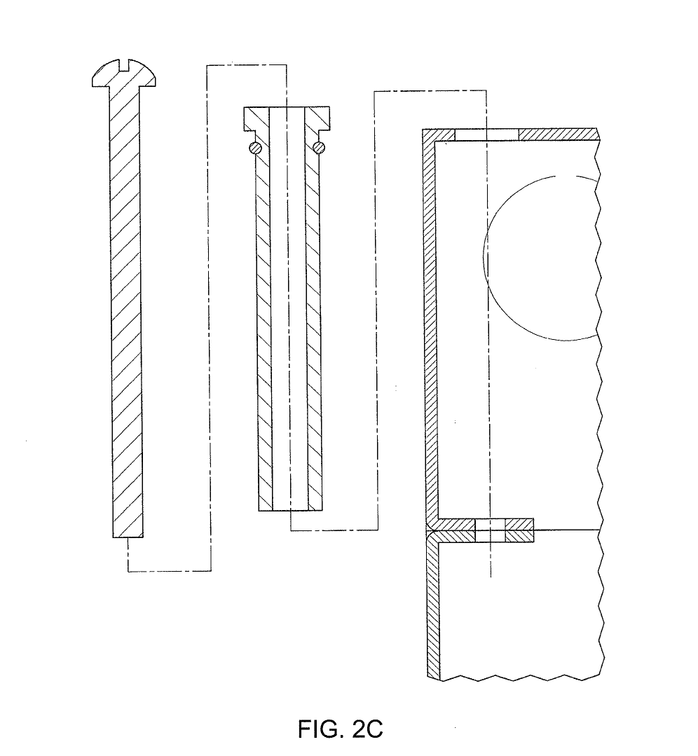

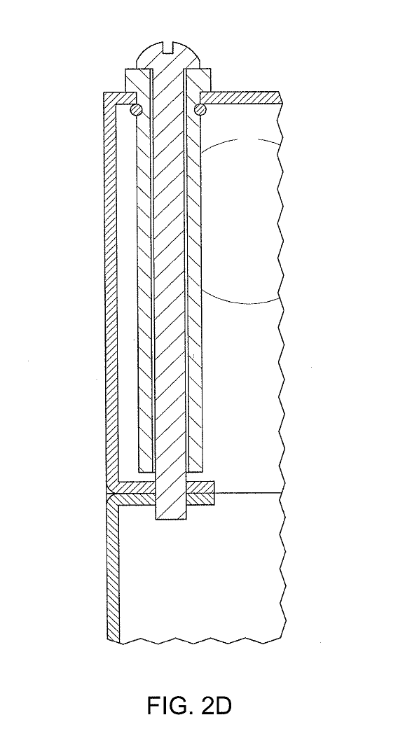

FIGS. 2A-2D show an embodiment in which expansion screws are inserted into isolating sleeves to secure two junction boxes together.

It is sometimes desirable to isolate the expansion screws from the energized conductors that will be inserted in the junction box. If the Underwriters Laboratories (UL) objects to the original application, a retro-fit kit could be obtained that contains the isolating sleeves and the longer expansion screws. The expansion screws are inserted into an isolating sleeve before being threaded into the screw hole in the pre-formed tab, as shown in FIG. 2A.

FIG. 2B shows the two junction boxes secured together with the expansion screws inserted through the isolating sleeve.

FIG. 2C shows the sequence of securing the two junction boxes together. The expansion screw is first inserted through the isolating sleeve, then the isolating sleeve containing the expansion screw is fed through the pre-formed hole or pre-formed knock-out hole, and finally the expansion screw is threaded through the screw hole in the pre-formed threaded tab at the corner of the first and second junction box.

FIG. 2D shows the two junction boxes secured by the expansion screw.

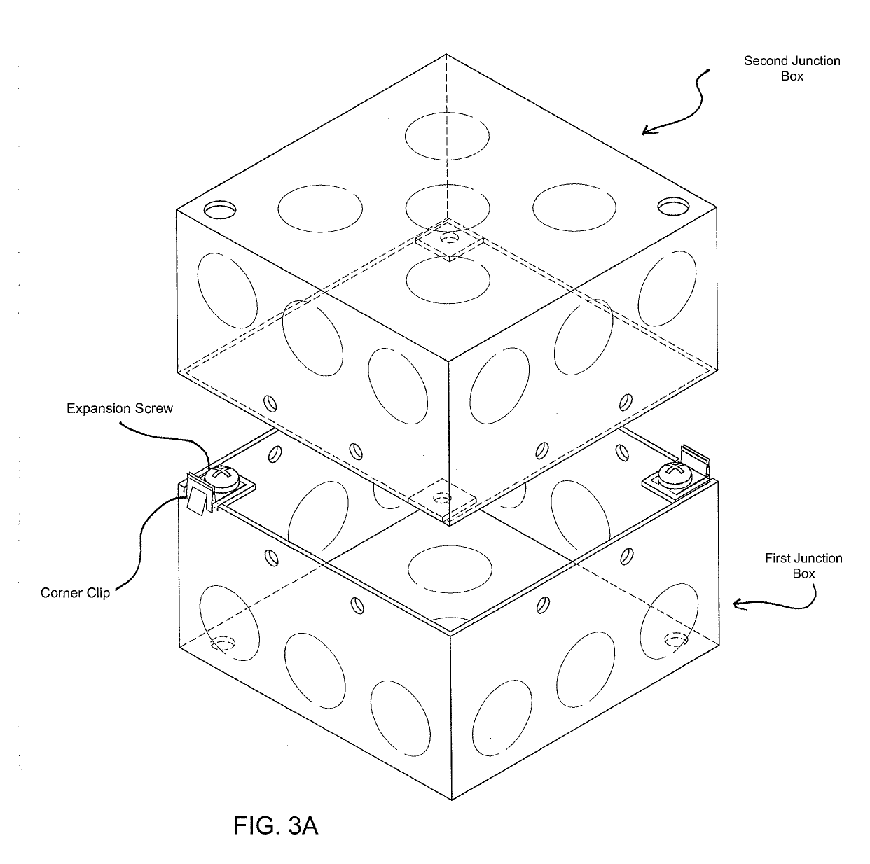

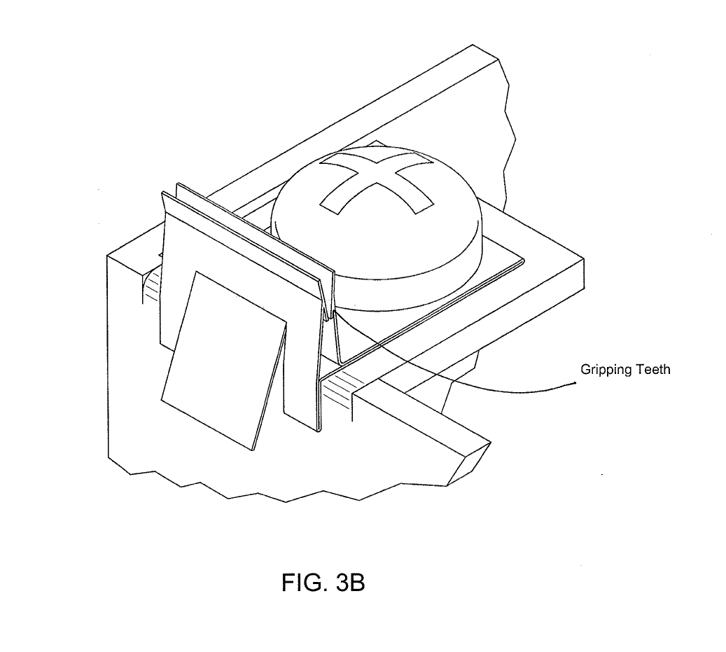

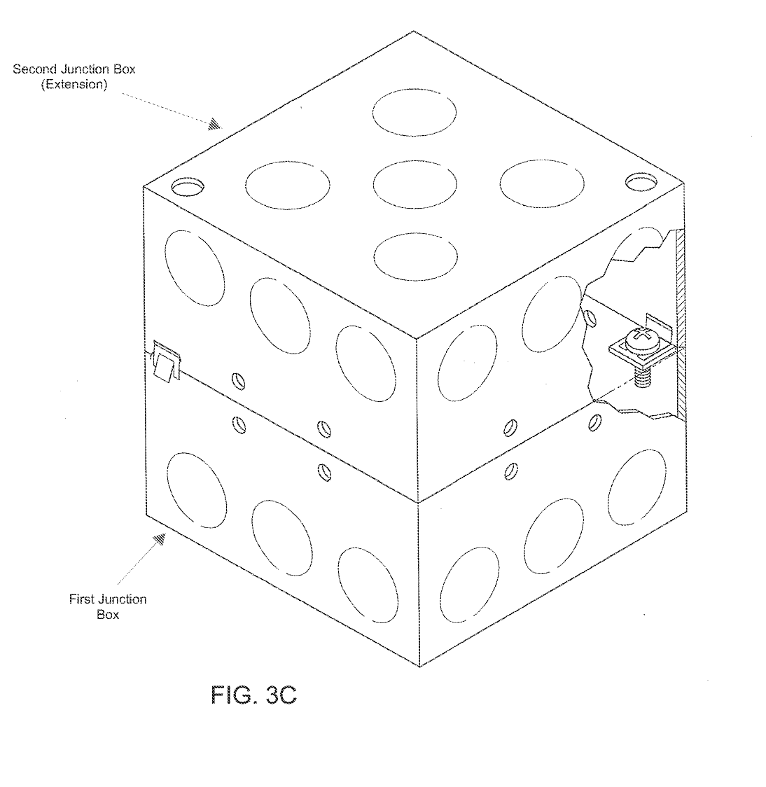

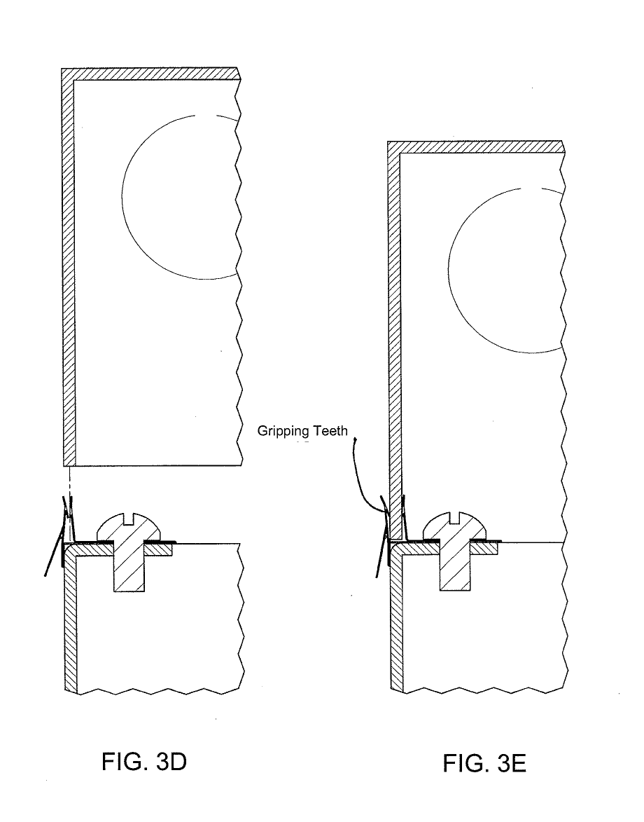

FIGS. 3A-3E show an embodiment in which two junction boxes are secured together with a corner clip that is affixed to one of the junction boxes with an expansion screw.

FIG. 3A shows the expansion screw threaded into a corner clip, and then into the screw hole in the pre-formed tab of the second junction box.

FIG. 3B is a close-up view that shows the gripping teeth of the corner tab.

FIG. 3C shows the first junction box secured in contact with the second junction box. The second junction box is held in place by the gripping teeth of the corner clip. The corner clip is secured to the first junction box by an expansion screw.

FIG. 3D shows a close-up view of the gripping teeth of the corner tab, before the first junction box is secured to the second junction box.

FIG. 3E shows a close-up view of the corner tab, after the first junction box is secured to the second junction box.

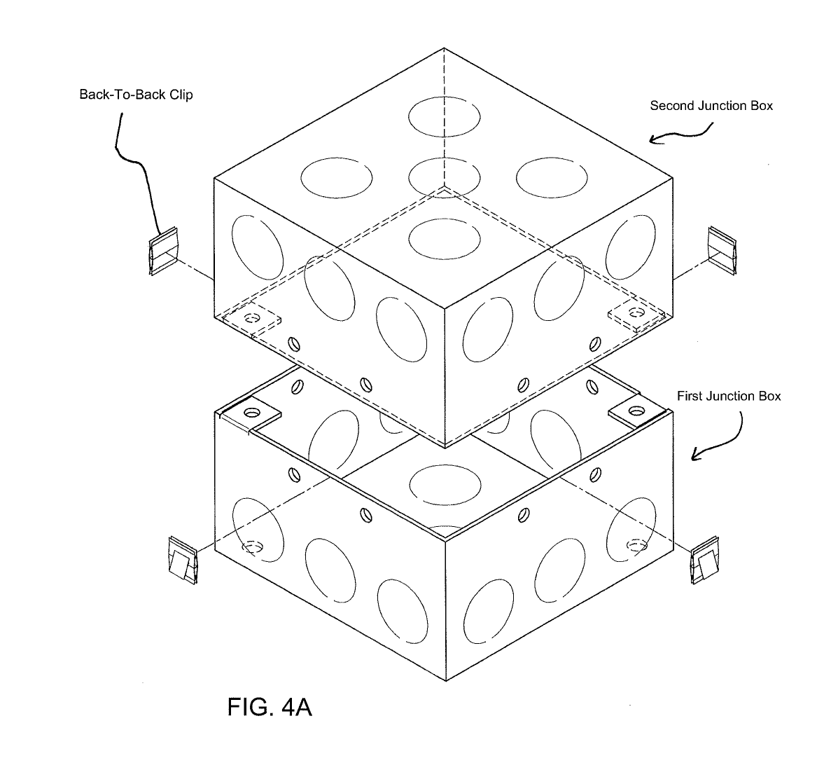

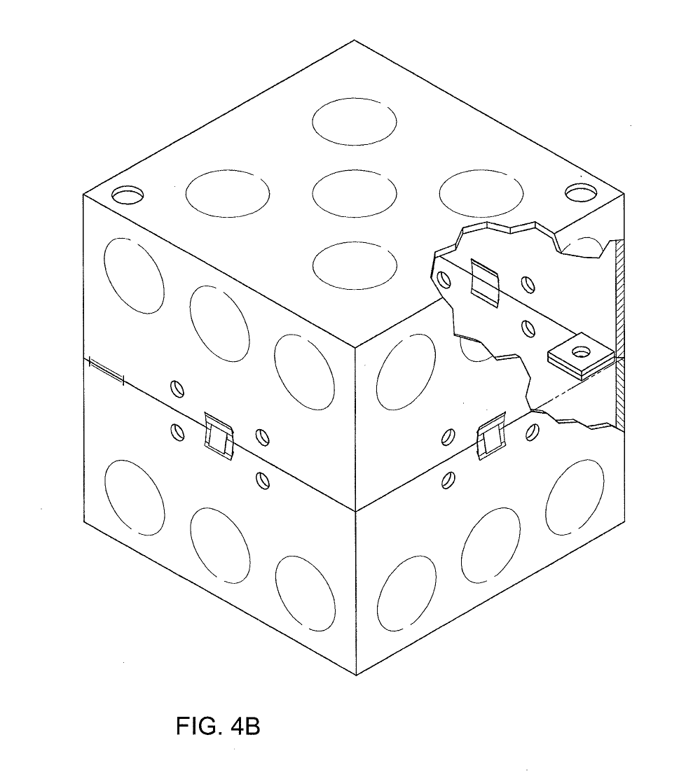

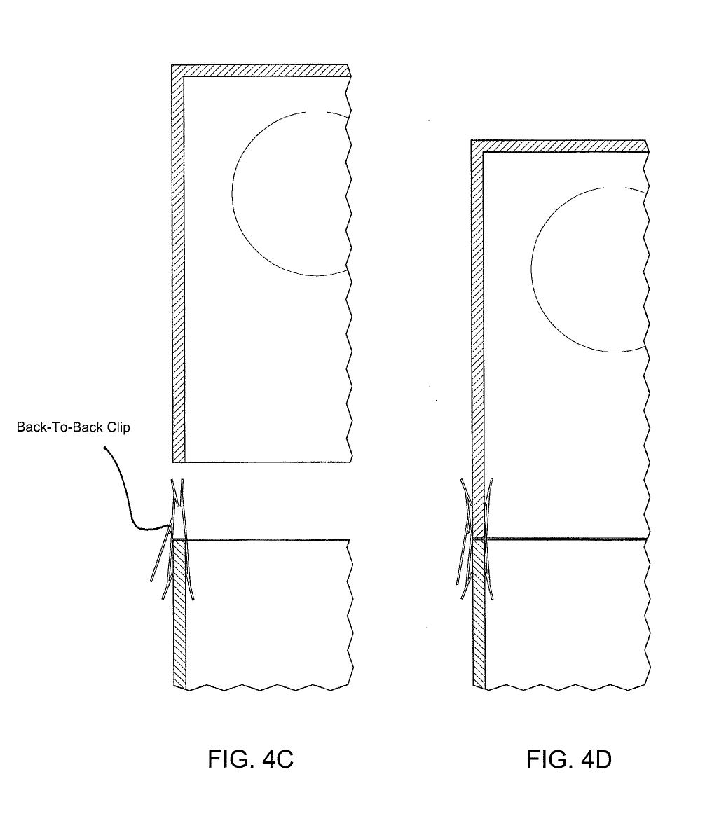

FIGS. 4A-4D show an embodiment in which two junction boxes are secured together with back-to-back clips.

FIG. 4A shows the first and second junction boxes and the back-to-back clips.

FIG. 4B shows the two junction boxes secured together with four back-to-back clips.

FIG. 4C shows a close-up view of the back-to-back clip, before the first junction box is secured to the second junction box.

FIG. 4D shows a close-up view of the back-to-back clip, after the first junction box is secured to the second junction box.

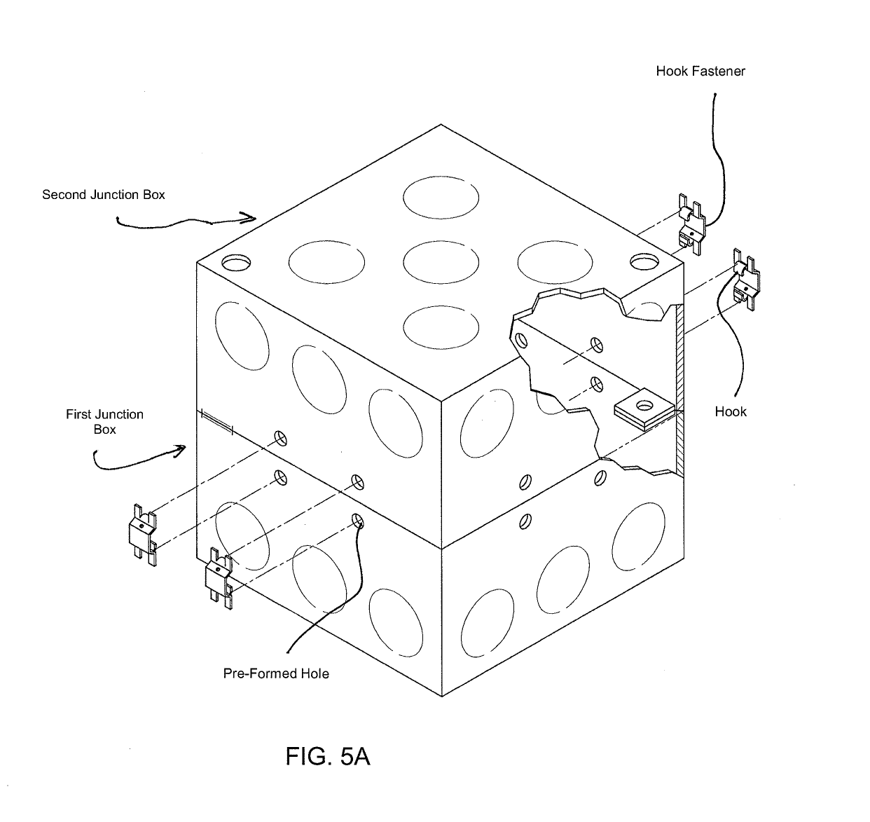

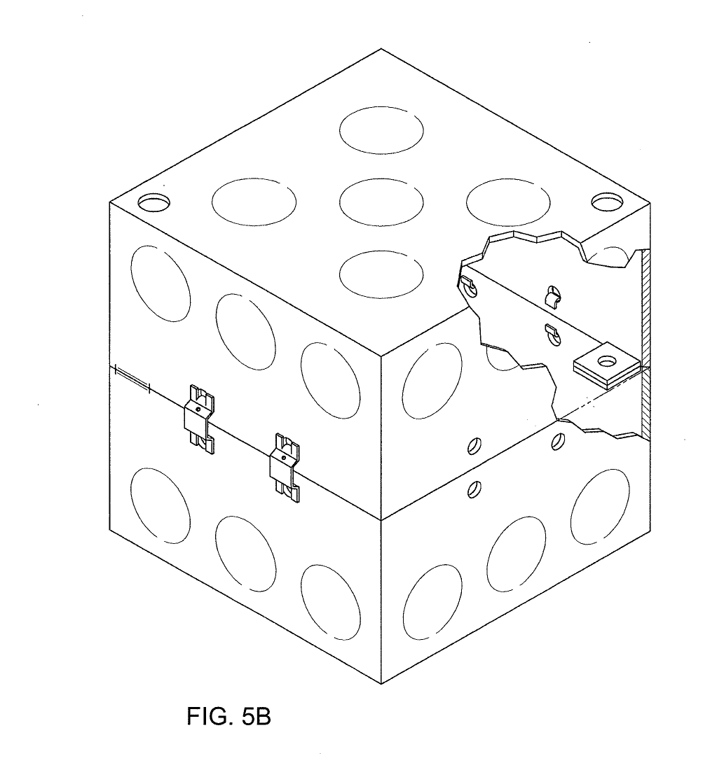

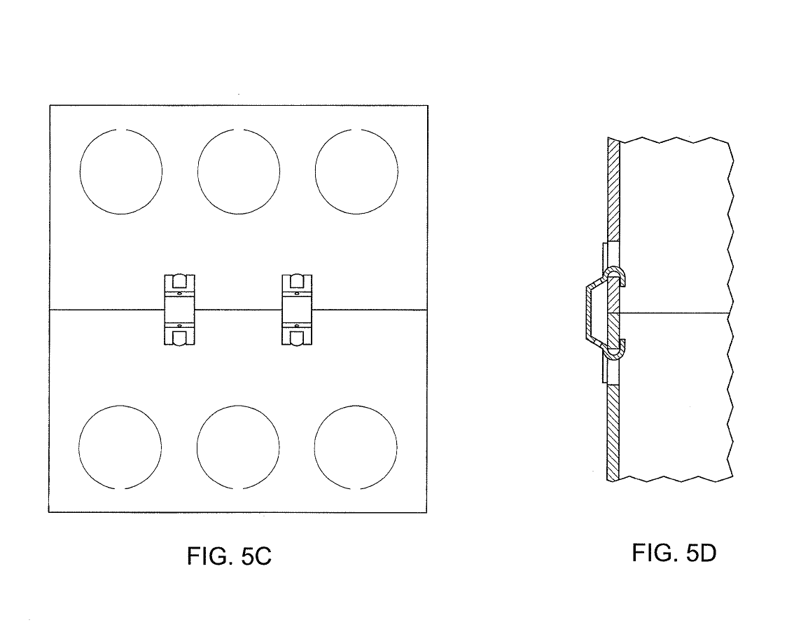

FIGS. 5A-5D show an embodiment in which two junction boxes are secured together with hook fasteners.

FIG. 5A shows the two junction boxes and the hook fasteners.

FIG. 5B shows the two junction boxes, secured by four hook fasteners.

FIG. 5C is an outside view of the two junction boxes, secured by hook fasteners.

FIG. 5D is a side view of the two junction boxes, secured by hook fasteners. The hooks have been inserted into the pre-formed holes of the first and second junction boxes.

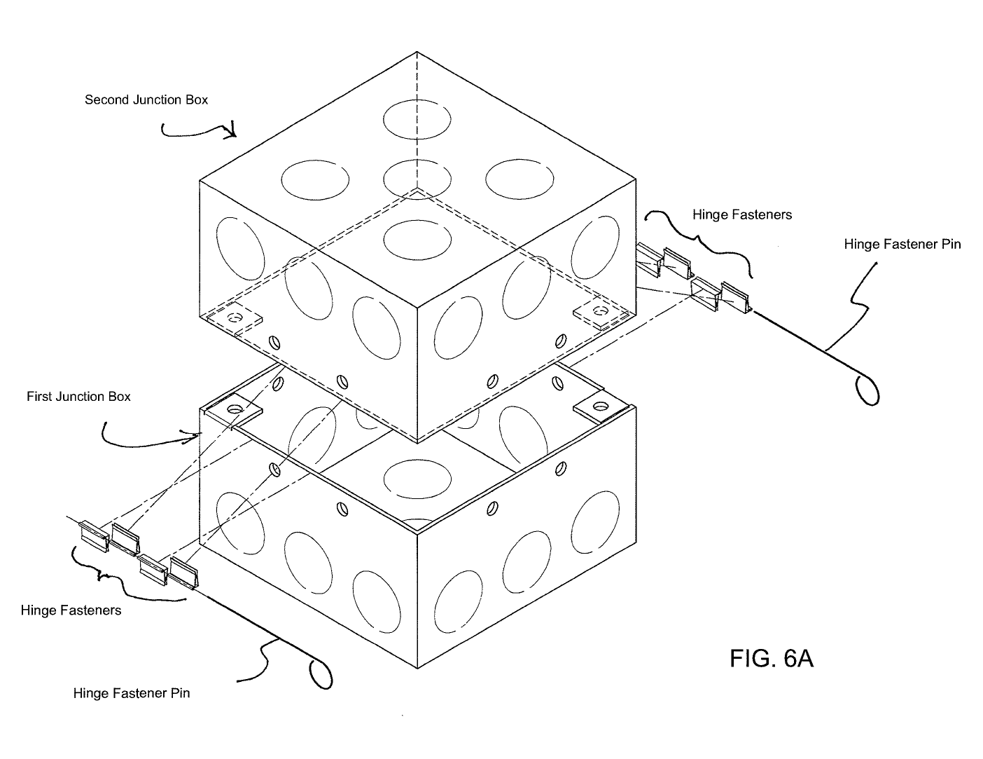

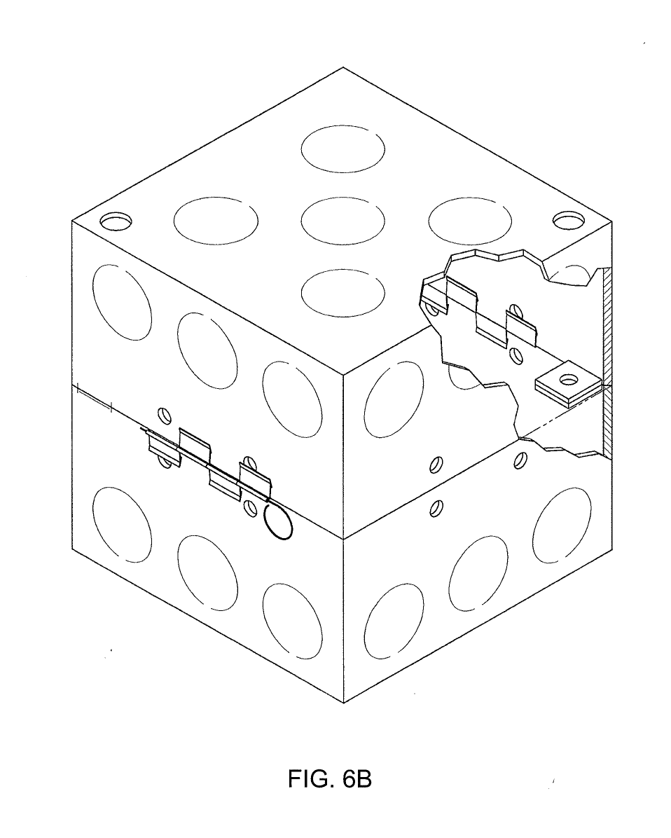

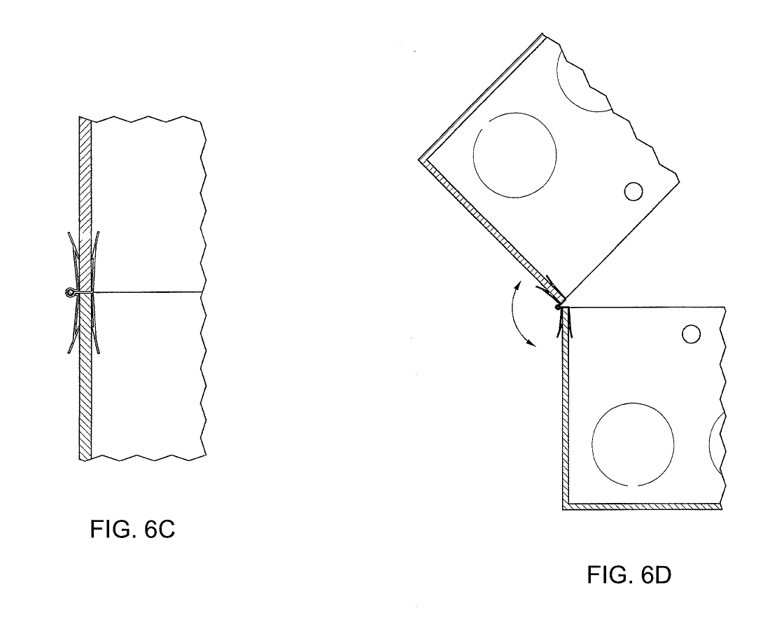

FIGS. 6A-6D show an embodiment in which two junction boxes are secured together with hinge fasteners.

FIG. 6A shows the two junction boxes that are to be secured together with two sets of four hinge fasteners. For each set of four fasteners, two of the hinge fasteners are attached to the first junction box, and two are attached to the second junction box. A hinge fastener pin is inserted through the hinge fasteners to secure the first and second junction boxes together.

FIG. 6B is an outside view of the two junction boxes, secured by the hinge fasteners.

FIG. 6C is a side view of the two junction boxes, secured by hinge fasteners.

FIG. 6D is a side view of the two junction boxes, secured by hinge fasteners. In FIG. 6D, the hinge fastener is only employed on one side of the junction boxes. This creates a hinge, and allows the two junction boxes to pivot relative to each other, as shown in FIG. 6D.

For the purposes of describing and defining the present invention, it is noted that a terms like “common,” or “standard,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims.

What is claimed is:

1. A method for extending the volume of an electrical junction box substantially as illustrated and described herein.

2. A method for extending the volume of an electrical junction box including one or more of the novel features illustrated and described herein.

3. A method for extending the volume of an electrical junction box wherein a second, substantially similar electrical junction box is secured to a first electrical junction box.
